(19) United States
(12) Patent Application Publication
(10) Pub. No.: US 2017/0160189 A1
(43) Pub. Date: Jun. 8, 2017

(54) OPTICAL ANALYSIS SYSTEM AND PROCESS

(71) Applicant: CIRTEMO, LLC, Cayce, SC (US)

(72) Inventor: Ryan J. PRIORE, Wexford, PA (US)

(73) Assignee: CIRTEMO, LLC, Cayce, SC (US)

(21) Appl. No.: 15/038,987

(22) PCT Filed: Nov. 21, 2014
(86) PCT No.: PCT/US2014/066807

§ 371 Date: May 24, 2016

Related U.S. Application Data
(60) Provisional application No. 61/909,862, filed on Nov. 27, 2013.

(51) Int. Cl. G01N 21/25; G01J 3/02

(52) U.S. Cl. CPC G01N 21/255; G01J 3/0205; G01N 2201/062; G01N 2201/06113

(57) ABSTRACT

An optical analysis system and process are disclosed. The optical analysis system includes one or more optical filter mechanisms disposed to receive light from a light source and a detector mechanism configured for operative communication with the one or more optical filter mechanisms, the operative communication permitting measurement of properties of filtered light, filtered by the one or more optical filter mechanisms followed by optical filtering by the mosaic optical filter mechanism from the light received. The one or more optical filter mechanisms are configured so that the magnitude of the properties measured by the detector mechanism is proportional to information carried by the filtered light. The process uses the optical analysis system.

### PRIORITY

The present application is a non-provisional patent application claiming priority and benefit to U.S. provisional patent application No. 61/909,862, filed Nov. 27, 2013, the entirety of which is hereby incorporated by reference.

### FIELD OF THE INVENTION

The present disclosure is in the technical field of spectroscopic imaging. More particularly, the disclosure relates to multivariate optical computing detection systems, devices, and processes.

### BACKGROUND OF THE INVENTION

Chemical analysis usually includes two processes: calibration and prediction. Calibration is the process of defining a mathematical model to relate an instrumental response or responses to a chemical or physical property of a sample. An instrument may yield one, two or multiple responses which are termed as variables. One output variable is referred to as a univariate measurement whereas multiple output variables are referred to as a multivariate measurement. Prediction is the act of using a calibration model based on a known chemical or physical property of a sample and predicting the properties of future samples from the instrumental output response variables.

A specific example of multivariate calibration and prediction in analytical spectroscopy is employing measured optical phenomena like absorbance (UV-visible, near infrared or long wave infrared), fluorescence or Raman data at specific wavelengths to predict the concentration of a target analyte in a gas, liquid or solid. Analytical chemists strive to produce linear calibration models which possess the highest level of accuracy and precision to selectively relate an instrumental output to a property of a desired analyte species even in the presence of instrumental output interferences. These interferences may occur due to chemical or physical properties of the sample matrix or other species and ultimately affect the sensitivity of the instrumental calibration.

Calibration models capable of correlating a measured response with a chemical or physical attribute originate from the field of statistics and in chemical systems, chemometrics. Chemometrics encompasses the use of statistical information to analyze chemical data to transform measured values into information for making decisions.

Multivariate Optical Computing (MOC) combines the data collection and processing steps of a traditional multivariate chemical analysis in a single step. It offers an all-optical computing technology with little to no moving parts. MOC instrumentation is inexpensive to manufacture compared to scanning instrumentation in a compact, field-portable design. The speed benefit due to an optical regression can offer real-time measurements with relatively high SNR that realize the advantages of chemometrics in a simple instrument. A Multivariate Optical Element (MOE) is a thin film interference filter that employs the principles of MOC by applying a dot product between the optical properties of the interference filter (transmission, reflection, etc.) with an incident radiometric quantity yielding a single measured value related to a spectroscopically active chemical or physical property.

A Bayer filter mosaic is an array of Red (R), Green (G) and Blue (B) color filters on a rectangular grid of photosensors. These simple, color sensitive photosensors are also typically referred to as RGB cameras and is used in most single-chip digital image sensors used in digital cameras, camcorders, and scanners for color image detection. Such mosaic filters like the Bayer filter pattern are typically combined with a short pass optical filter in order to restrict the detector sensitivity to the intended red, green and blue color channels.

Other features and advantages of the present invention will be apparent from the following more detailed description of the preferred embodiment, taken in conjunction with the accompanying drawings which illustrate, by way of example, the principles of the invention.

### BRIEF SUMMARY OF THE INVENTION

In an embodiment, an optical analysis system includes one or more optical filter mechanisms disposed to receive light from a light source and a detector mechanism configured for operative communication with the one or more optical filter mechanisms, the operative communication permitting measurement of properties of filtered light, filtered by the one or more optical filter mechanisms followed by optical filtering by the mosaic optical filter mechanism from the light received. The one or more optical filter mechanisms are configured so that the magnitude of the properties measured by the detector mechanism is proportional to information carried by the filtered light.

In another embodiment, an optical analysis system includes one or more optical filter mechanisms disposed to modulate light from a broadband light source and a detector mechanism, the operative communication permitting measurement of properties of filtered light, filtered by the one or more optical filter mechanisms followed by optical filtering by the mosaic optical filter mechanism from the light received. The one or more optical filter mechanisms are configured so that the magnitude of the properties measured by the detector mechanism is proportional to information carried by the filtered light.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

A full and enabling disclosure of the present subject matter, including the best mode thereof to one skilled in the art, is set forth more particularly in the remainder of the specification, including reference to the accompanying figures, in which:

FIG. 1 is a schematic of a combined MOE and traditional mosaic RGB camera sensor for detection of visible electromagnetic radiation.

FIG. 2 is a plot of the relative responsivity of the various camera components in addition to a representative MOE for the detection of visible electromagnetic radiation.

FIG. 3 is a plot of the convolved relative responsivity of the three camera “color” channels for the detection of visible electromagnetic radiation.

FIG. 4 illustrates the possible regression vectors that may be constructed from the combinations of discrete RGB sensor or imager measurements according to each “color” channel when employing a hot mirror and a representative MOE.

FIG. 5 is a schematic of a combined MOE and a mosaic RGB camera sensor without a short pass or “hot filter” for detection of visible and SWIR electromagnetic radiation.

FIG. 6 is a plot of the relative responsivity of the various camera components in addition to a representative MOE for the detection of visible and SWIR electromagnetic radiation.

FIG. 7 is a plot of the convolved relative responsivity of the three camera “color” channels for the detection of visible and SWIR electromagnetic radiation.

FIG. 8 illustrates the possible regression vectors that may be constructed from the combinations of discrete RGB sensor or imager measurements according to each “color” channel when employing a hot mirror and a representative MOE.

FIG. 9 is a schematic of a combined single-MOE and mosaic RGB camera sensor in which the MOE is placed in a collimated path prior to focusing the incident light onto the RGB sensor.

FIG. 10 is a schematic of a combined multi-MOE and mosaic RGB camera sensor in which the MOEs are placed in a collimated path prior to focusing the incident light onto the RGB sensor.

FIG. 11 is a schematic of a combined MOE and mosaic RGB camera sensor in which the MOE is placed just prior to the RGB sensor.

FIG. 12 is a schematic of a combined multi-MOE and mosaic RGB camera sensor in which the MOEs are placed in front of the light source.

Wherever possible, the same reference numbers will be used throughout the drawings to represent the same parts.

### DETAILED DESCRIPTION OF THE INVENTION

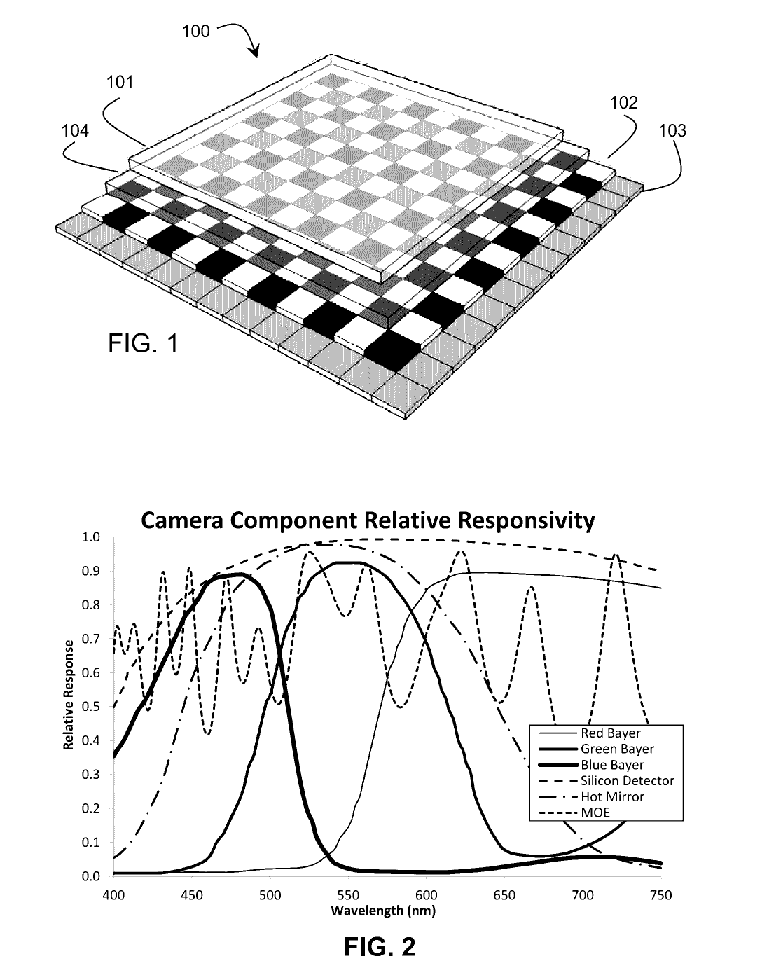

Referring now to various embodiments of the disclosure in more detail, in FIG. 1 is a schematic of a combined MOE and RGB camera sensor (100). The MOE (101) is coupled to a traditional RGB camera or sensor which utilizes a mosaic pattern filter like the Bayer pattern (102) coupled directly to the silicon detector elements (103) in order to detect optically weighted discrete (R)ed, (G)reen and (B)lue color channel intensities. The final image reconstruction occurs by demosaicing the imposed pattern (102) to yield 1 pixel of information for each pattern kernel. A short pass or “hot mirror” (104) limits the optical passband of the incident light to the visible region of the electromagnetic spectrum.

Referring now to FIG. 2, the relative camera component responses are plotted as a function of wavelength. By example, the transmission of each Red, Green and Blue Bayer filter is illustrated along with a representative MOE transmission. A short pass or “hot mirror” is employed in order to suppress additional IR photons from the RGB detection elements. The camera or sensor is silicon-based which offers a detection window from 400-700 nm with the “hot mirror” installed.

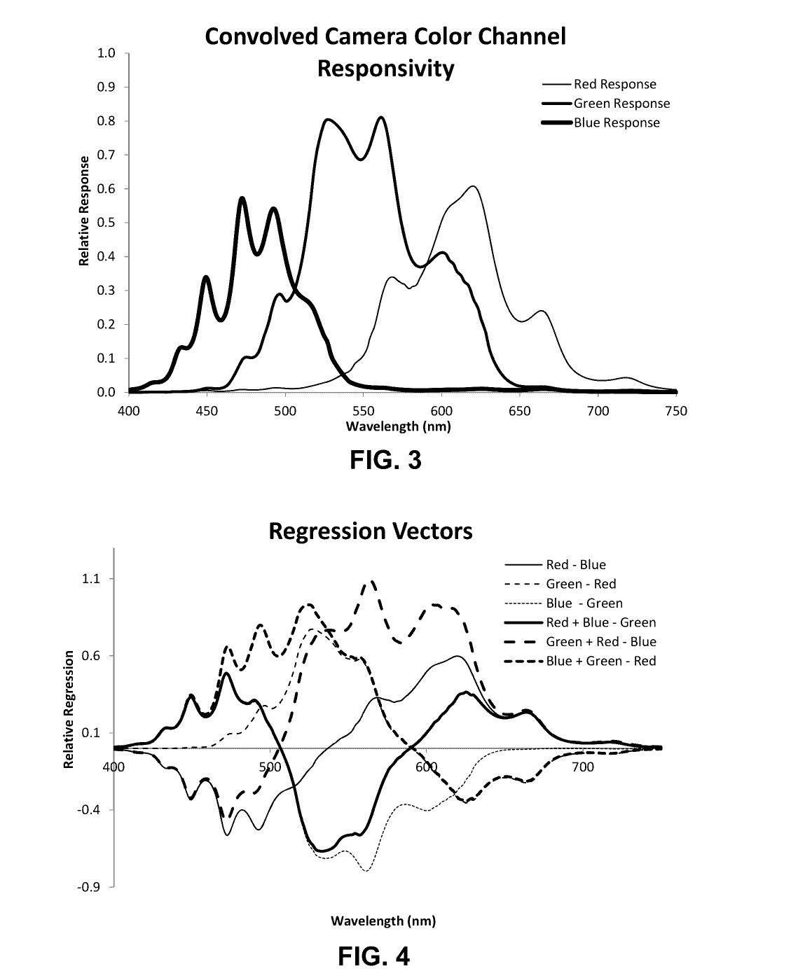

Referring now to FIG. 3, the apparent “color” channels represent the convolved spectroscopic response of the detector, short pass filter or “hot mirror” and representative MOE with the discrete Red, Green and Blue filters. The integrated area under each of the RGB spectroscopic responsivity curves represents the detected optical signal for each “color” detection element with a detection window from 400-700 nm with the “hot mirror” installed.

Referring now to FIG. 4, by way of example using the representative MOE and Bayer color filters, each employed MOE yields six possible regression vectors based upon linear combinations of the discrete RGB detection elements and a total of six possible regression vectors. Additional regression vectors may also be constructed by introducing a coefficient or scalar multiplier before each discrete RGB detection element.

In further detail, in FIG. 4 an intra-optimization may be performed in order to yield a single MOE that employs one or more “color” channels to construct a spectroscopic loading vector. Alternatively one or more MOEs may be designed/optimized to perform an application specific measurement. Intra- or inter-optimization of multiple MOEs may be designed/optimized to perform a compressed detection measurement for full spectroscopic reconstruction or direct analyte property classification.

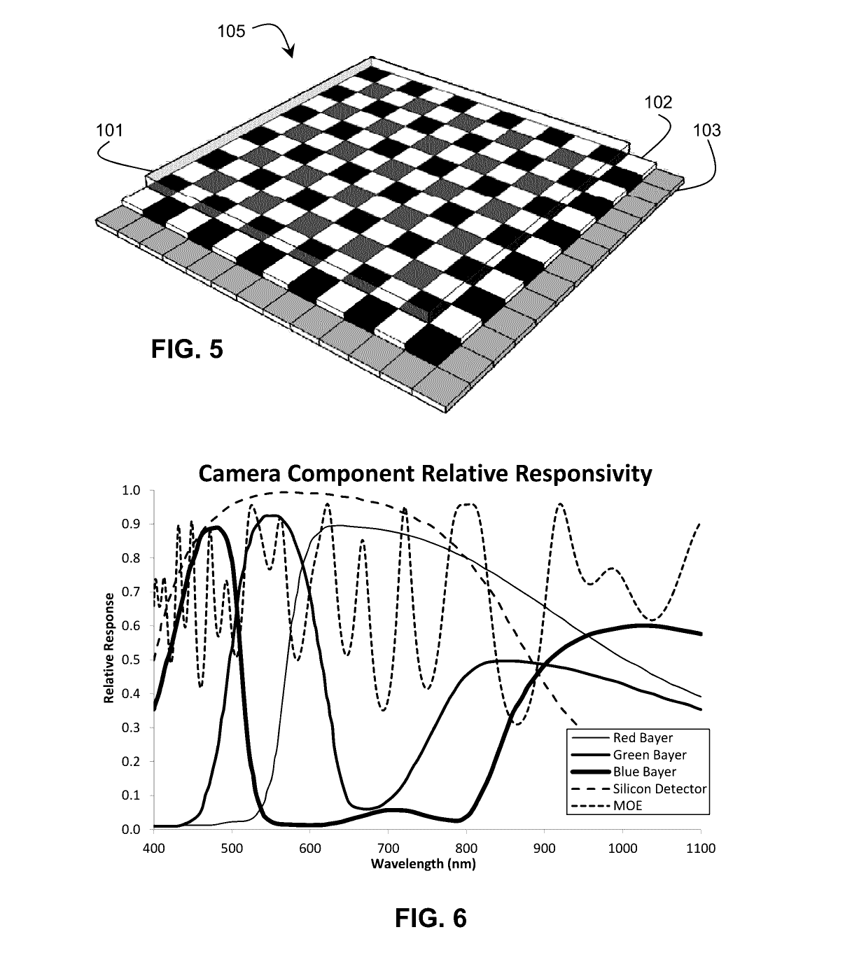

Referring now to FIG. 5, a schematic of a combined MOE and RGB camera sensor (105) is illustrated without the short pass filter or “hot mirror”. The MOE (101) is coupled to a traditional RGB camera or sensor which utilizes a mosaic pattern filter like the Bayer pattern (102) coupled directly to the silicon detector elements (103) in order to detect optically weighted discrete (R)ed, (G)reen and (B)lue color channel intensities. The final image reconstruction occurs by demosaicing the imposed pattern (102) to yield 1 pixel of information for each pattern kernel. Since a short pass or “hot mirror” is not employed, the optical passband of the incident light extends from the visible to the SWIR region of the electromagnetic spectrum.

Referring now to FIG. 6, the relative camera component responses are plotted as a function of wavelength. By example, the transmission of each Red, Green and Blue Bayer filter is illustrated along with a representative MOE transmission. The camera or sensor is silicon-based which offers a detection window from 400-1100 nm without the “hot mirror” installed.

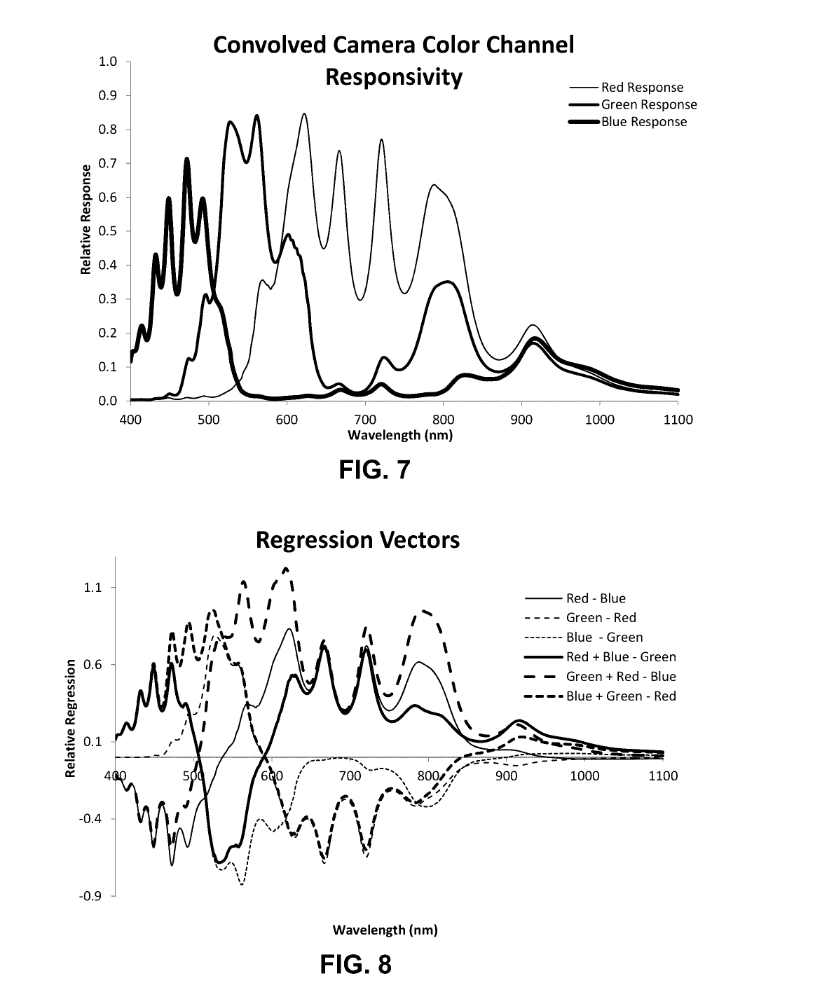

Referring now to FIG. 7, the apparent “color” channels represent the convolved spectroscopic response of the detector and representative MOE with the discrete Red, Green and Blue filters. The integrated area under each of the RGB spectroscopic responsivity curves represents the detected optical signal for each “color” detection element with a detection window from 400-1100 nm without the “hot mirror” installed.

Referring now to FIG. 8, by way of example using the representative MOE and Bayer color filters, each employed MOE yields six possible regression vectors based upon linear combinations of the discrete RGB detection elements and a total of six possible regression vectors. Additional regression vectors may also be constructed by introducing a coefficient or scalar multiplier before each discrete RGB detection element.

In further detail, in FIG. 8 an intra-optimization may be performed in order to yield a single MOE that employs one or more “color” channels to construct a spectroscopic loading vector. Alternatively one or more MOEs may be designed/optimized to perform an application specific measurement. Intra- or inter-optimization of multiple MOEs may be designed/optimized to perform a compressed detection measurement for full spectroscopic reconstruction or direct analyte property classification.

In further design, MOEs are designed by iterative solving using computer simulations based upon a user defined set of standard data. Such sample data includes but is not limited to sample spectra, analyte concentrations/classifications for each spectrum and optical instrument radiometry. Software produces a random design for a multilayer stack (within limits defined by the user), and then calculates the spectrum of that stack. The spectrum of the stack is then used to calculate a difference among the apparent “color” channel intensities for each sample in the standard data. The correlation of these spectral intensities with the standard characteristics of the samples is determined, and then the stack is modified slightly to see if the modification improves the correlation.

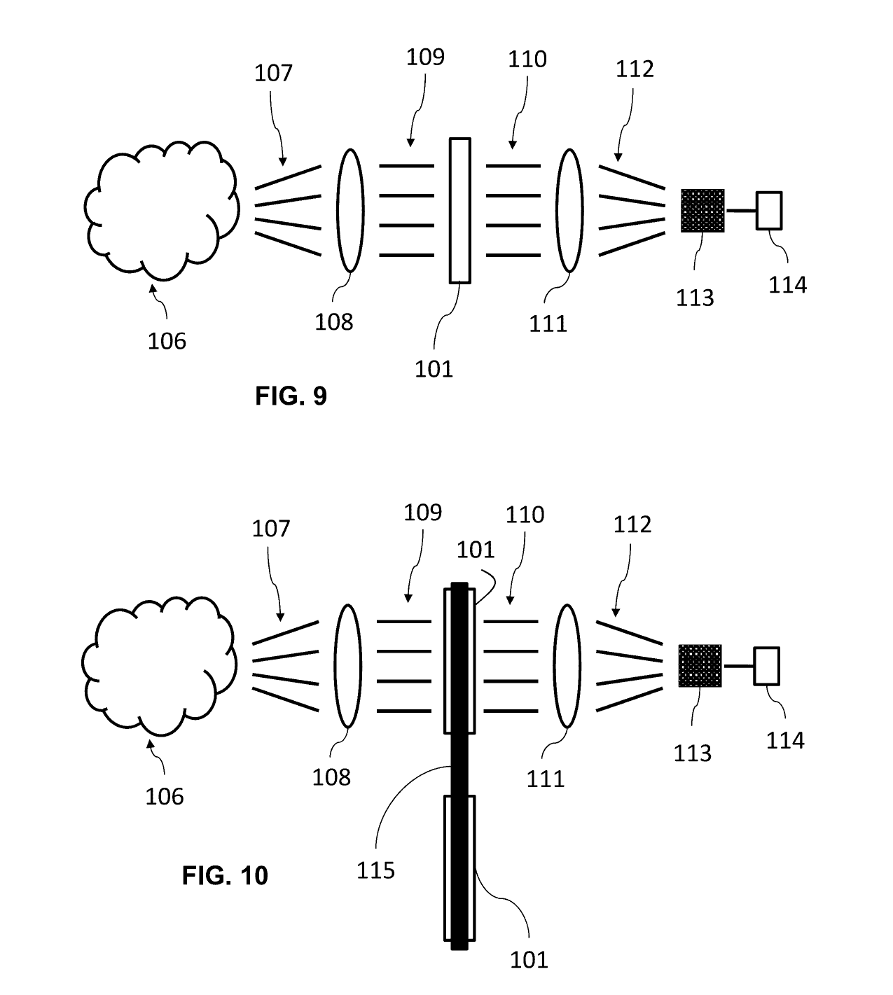

Referring now to FIG. 9, there is shown a sample (106) in which sampled light (107) is focused by a collimating lens (108) whereby the collimated light (109) is transmitted through an MOE (101). The light transmitted through the optical filter (110) is focused by a focusing lens (111), and the focused light (112) is passed to a mosaic filtered optical detector (113) controlled by a microcontroller (114).

In further detail, in FIG. 9 the independent measurements made by the optical detector (113) are used to compute an estimate of the fully resolved wavelength spectrum of the sample or a direct analyte property classification.

Referring now to FIG. 10, there is shown a sample (106) in which sampled light (107) is focused by a collimating lens (108) whereby the collimated light (109) is transmitted through an MOE (101) positioned on an optical filter wheel (115). The light transmitted through the optical filter (110) is focused by a focusing lens (111), and the focused light (112) is passed to a mosaic filtered optical detector (113) controlled by a microcontroller (114).

In further detail, in FIG. 10 the independent measurements made by the optical detector (113) are used to compute an estimate of the fully resolved wavelength spectrum of the sample or a direct analyte property classification.

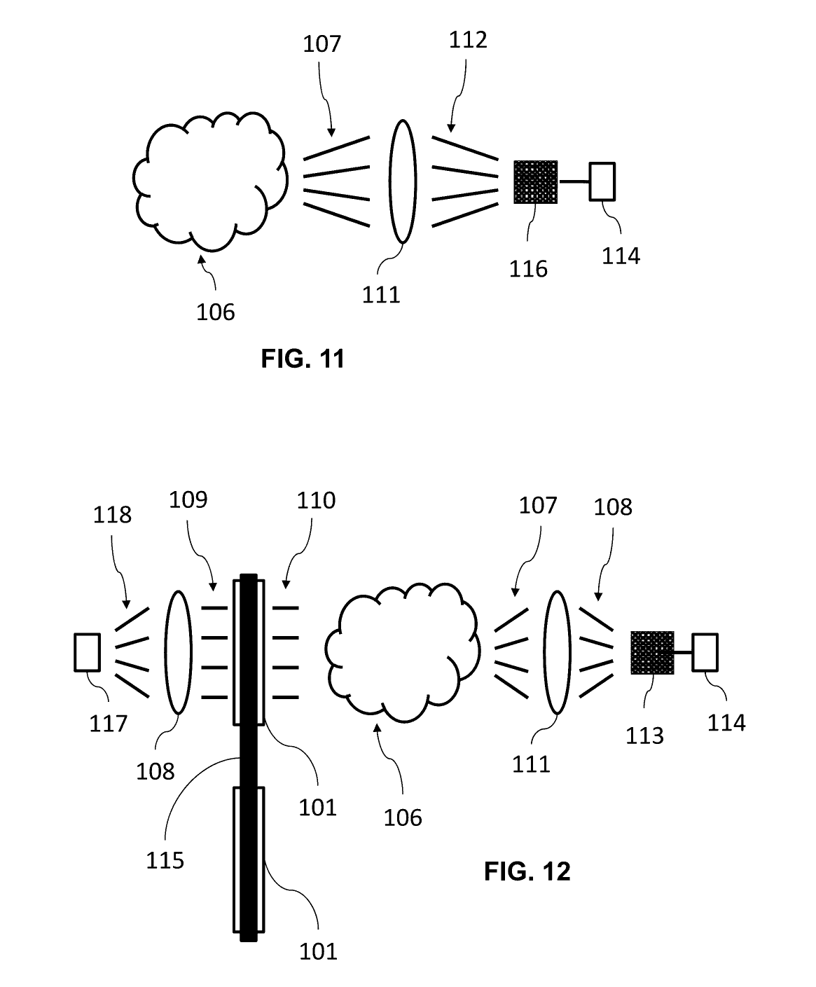

Referring now to FIG. 11, there is shown a sample (106) in which sampled light (107) is focused by a focusing lens (111), and the focused light (112) is passed to a combined MOE and mosaic filtered optical detector (116) controlled by a microcontroller (114). Such combined MOE and mosaic filtered optical detectors include 100 and 105.

Referring now to FIG. 12, there is shown a broadband light source (117) in which the emitted light is collimated using a collimating lens (108). The collimated light (109) is transmitted through an MOE (110) positioned on an optical filter wheel (115), and the transmitted light (110) illuminates a sample (106) in which sampled light (107) is focused by a focusing lens (111), and the focused light (112) is passed to a combined MOE and mosaic filtered optical detector (116) controlled by a microcontroller (114). Such combined MOE and mosaic filtered optical detectors include 100 and 105.

Among other things, the embodiments of the present disclosure have the ability to compute a fully resolved optical spectrum or hyperspectral image with M discrete wavelength variables from a set of N optical filter measurements where N is smaller than M.

The sample (106) can be realized in a variety of different ways from liquids, solids, slurries or biological tissue. Suitable uses include blood or tissue oxygenation such as retinal oximetry, pulse oximetry, hypoxia and wound healing monitoring by detection of oxygen saturation.

Other suitable uses include, but are not limited to, wound care, conversion of hydrocarbons into plastics, fertilizers and other non-fuel chemicals production and the transportation thereof, any form of chemical processing of and associated with any compound (but excluding the processing of hydrocarbons for fuel or petrochemical) and the transportation thereof, food processing, beverage processing, formulation chemistry and mixing, pharmaceutical processing, ocean science, biomedical science, life sciences, processing of minerals, coal, semiconductor processing, stack gas and environmental monitoring, agricultural measurements, planetary sciences, astronomy, atmospheric science, waste treatment monitoring, aquifer testing, water testing, forensic crime scene analysis and other applications to criminal justice, explosives and explosive residue detection, and detection of corrosive or toxic chemicals, cellular phone or tablet computing devices, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An optical analysis system, comprising:
one or more optical filter mechanisms disposed to receive light from a light source followed by optical filtering by a mosaic optical filter mechanism; and
a detector mechanism configured for operative communication with the one or more optical filter mechanisms, the operative communication permitting measurement of properties of filtered light, filtered by the one or more optical filter mechanisms from the light received;
wherein the one or more optical filter mechanisms are configured so that the magnitude of the properties measured by the detector mechanism is proportional to information carried by the filtered light.

2. The system according to claim 1, wherein the one or more optical filter mechanisms comprise at least one multivariate optical element.

3. The system according to claim 1, wherein the one or more optical filter mechanisms comprise at least one neutral density filter.

4. The system according to claim 1, wherein the one or more optical filter mechanisms comprise at least one band pass filter.

5. The system according to claim 1, wherein the optical filter mechanism is a liquid crystal tunable filter (LCTF).

6. The system according to claim 1, wherein the optical filter mechanism is an acousto-optical tunable filter (AOTF).

7. The system according to claim 1, wherein the light source employed to generate light from the sample is selected from the group consisting of a broadband illumination light source, a light emitting diode (LED), laser, and combinations thereof.

8. The system according to claim 1, wherein the mosaic optical filter mechanism is an RGB camera.

9. The system according to claim 1, wherein the information carried by the filtered light relates to an analyte, the analyte being a fluorescent moiety.

10. The system according to claim 1, wherein the system is capable of use in tissue oxygenation and monitoring the tissue oxygenation process.

11. The system according to claim 1, wherein the system is capable of use in wound care and monitoring the wound healing process.

12. An optical analysis system, comprising:
one or more optical filter mechanisms disposed to modulate light from a broadband light source onto a sample of interest followed by optical filtering by a mosaic optical filter mechanism; and
a detector mechanism configured for operative communication with the one or more optical filter mechanisms, the operative communication permitting measurement of properties of filtered light, filtered by the one or more optical filter mechanisms from the light modulated;
wherein the one or more optical filter mechanisms are configured so that the magnitude of the properties measured by the detector mechanism is proportional to information carried by the filtered light.

13. The system according to claim 12, wherein the one or more optical filter mechanisms comprise at least one multivariate optical element.

14. The system according to claim 12, wherein the one or more optical filter mechanisms comprise at least one neutral density filter.

15. The system according to claim 12, wherein the one or more optical filter mechanisms comprise at least one band pass filter.

16. The system according to claim 12, wherein the optical filter mechanism is a liquid crystal tunable filter (LCTF).

17. The system according to claim 12, wherein the optical filter mechanism is an acousto-optical tunable filter (AOTF).

18. The system according to claim 12, wherein the light source employed to generate light from the sample is selected from the group consisting of a broadband illumination light source, a light emitting diode (LED), laser, and combinations thereof.

19. The system according to claim 12, wherein the detector mechanisms comprise a mosaic filtered RGB camera.

20. An optical analysis process, comprising:
detecting information about an analyte from filtered light;
wherein the filtered light is from one or more optical filter mechanisms disposed to receive or modulate light from a light source; and
wherein the detecting is by a detector mechanism configured for operative communication with the one or more optical filter mechanisms, the operative communication permitting measurement of properties of the filtered light, filtered by the one or more optical filter mechanisms from the light received or modulated;
wherein the one or more optical filter mechanisms are configured so that the magnitude of the properties measured by the detector mechanism is proportional to the information carried by the filtered light.
